(19) United States
(12) Patent Application Publication
(10) Pub. No.: US 2021/0163769 A1
(43) Pub. Date: Jun. 3, 2021

(54) INKJET INK COMPOSITION

(71) Applicant: Hewlett-Packard Development Company, L.P., Spring, TX (US)

(72) Inventors: Raymond Adamic, Corvallis, OR (US); Goeun Sim, Corvallis, OR (US)

(21) Appl. No.: 16/770,714

(22) PCT Filed: Apr. 12, 2018
(86) PCT No.: PCT/US2018/027349

§ 371 Date: Jun. 8, 2020

(51) Int. Cl. C09D 11/38; C09D 11/322; C09D 11/328; C09D 11/14; C09D 11/037; C09D 11/033; B41M 5/00

(52) U.S. Cl. CPC C09D 11/38; C09D 11/322; C09D 11/328; B82Y 30/00; C09D 11/037; C09D 11/033; B41M 5/0023; C09D 11/14

(57) ABSTRACT

An inkjet ink composition includes cellulose nanocrystals and a metal oxide. The cellulose nanocrystals are present in the inkjet ink composition in an amount ranging from 0.5 wt % up to 2 wt %, based on a total weight of the inkjet ink composition, and the metal oxide is present in the inkjet ink composition in an amount ranging from 0.5 wt % up to 7 wt %, based on the total weight of the inkjet ink composition. The inkjet ink composition further includes a pigment, a polar solvent and a balance of water.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Some commercial and industrial inkjet printers utilize fixed printheads and a moving substrate web in order to achieve high speed printing. Current inkjet printing technology involves forcing the ink drops through small nozzles by thermal ejection, piezoelectric pressure or oscillation onto the surface of the media. The technology has become a popular way of recording images on various media surfaces (e.g., paper), for a number of reasons, including, low printer noise, capability of high-speed recording and multi-color recording.

### BRIEF DESCRIPTION OF THE DRAWINGS

Features of examples of the present disclosure will become apparent by reference to the following detailed description and drawings.

FIG. 1 is a flow diagram of a method of making an example of the inkjet ink composition disclosed herein; and

FIGS. 2A and 2B are graphs showing the color saturation of example cyan inkjet ink compositions and comparative example cyan inkjet ink compositions (2A), and example magenta inkjet ink compositions and comparative example magenta inkjet ink compositions (2B) on enhanced paper and plain paper at different fill densities.

### DETAILED DESCRIPTION

In inkjet printing, the ink composition can affect both the printability of the ink and the print attributes of images that are formed with the ink. As such, ink performance, in terms of both printability and printed image attributes, may be controlled by modifying the components of the ink composition. However, adjusting an ink composition to achieve one attribute of ink performance may result in the compromise of another attribute. For example, increasing a binder amount in an ink can improve the durability of a printed image; however, an increase in binder can also deleteriously affect the printability of the ink by increasing the viscosity, which can lead to clogged nozzles in the printhead, etc. For another example, gelators may be added to an ink composition to improve optical density and/or color saturation; however, gelators can increase the solids content, which can lead to agglomerate formation (i.e., amount of precipitates that have accumulated in a printhead nozzle during a set time period), which can adversely affect print reliability and printhead nozzle health.

A single ink composition may also exhibit different print performance attributes on different types of media, due in part, to the different components within the different types of media. Print performance attributes that may vary from one media type to another may include color saturation of the printed image, dry times of the printed image, and durability of the printed image. An ink composition may form very different prints when printed, for example, on plain paper and on enhanced paper.

As used herein, “plain paper” refers to paper that has not been specially coated or designed for specialty uses (e.g., photo printing). Plain paper is composed of cellulose fibers and fillers. In contrast to an enhanced paper (described below), plain paper does not include an additive that produces a chemical interaction with a pigment in an ink that is printed thereon. Also as used herein, “enhanced paper” refers to paper that has not been specially coated, but does include the additive that produces a chemical interaction with a pigment in an ink that is printed thereon. The enhanced paper is composed of cellulose fibers, fillers, and the additive. An example of the additive is calcium chloride or another salt that instantaneously reacts with an anionic pigment present in the ink printed on the enhanced paper, which causes the pigment to crash out of the ink and fixes the pigment on the enhanced paper surface. As an example, the enhanced paper may be any standard paper that incorporates COLORLOK® Technology (International Paper Co.). Both plain paper and enhanced paper are commercially available as general office printer and/or copier papers, but, as previously mentioned, the enhanced paper incorporates the COLORLOK® Technology. Examples of plain paper used herein include Georgia-Pacific Spectrum Multipurpose paper (from Georgia-Pacific), and Hammermill Great White 30 (from Hammermill). An example of enhanced paper used herein is HP® Multipurpose paper media with COLORLOK® technology (from HP Development Company).

An inkjet ink composition is disclosed herein that exhibits print reliability, as well as relatively consistent print performance attributes on both plain paper and enhanced paper. As illustrated in the examples set forth herein, the inkjet ink composition can be digitally jetted with an inkjet printhead, such as a thermal inkjet printhead or a piezoelectric inkjet printhead.

The inkjet ink composition incorporates particular amounts of cellulose nanocrystals and a metal oxide. Without being bound to any theory, it is believed that these components and their respective amounts have a synergistic effect which renders the ink performance independent of the components of the paper upon which it is printed. In some examples, the particular amounts of the cellulose nanocrystals and the metal oxide are used in combination with particular amounts of each of a sugar alcohol and an organic salt. It is believed that these particular amounts further contribute to the synergistic effect.

The combination of cellulose nanocrystals and metal oxide can interact with ink pigments to create a shear thinning network which maintains association with the pigments to improve color performance, especially on plain paper. The viscosity attained by the combination of the particular amounts of cellulose nanocrystals and metal oxide renders the inkjet ink composition suitable for use in either thermal inkjet printheads or piezoelectric inkjet printheads. In an example, such as when the inkjet ink composition is intended for use with thermal inkjet printheads, the cellulose nanocrystals and metal oxide may be combined in amounts that allow for a final ink solids content that is less than or equal to 8%. This solids content may alleviate numerous print reliability issues that may be observed with thermal inkjet inks having a higher solids content, while providing room for durability enhancing materials (e.g., the sugar alcohol, binder, latex, etc.) in the ink composition and contributing to overall higher ink efficiency. In another example, such as when the inkjet ink composition is intended for use with piezoelectric inkjet printheads, the cellulose nanocrystals and metal oxide may be combined in the ink composition in amounts that allow for a final ink solids content ranging from about 10% to about 25% without having a deleterious effect on print reliability or print performance.

An example of the inkjet ink composition comprises cellulose nanocrystals present in an amount ranging from 0.5 wt % up to 2 wt %, based on a total weight of the inkjet ink composition, a metal oxide present in an amount ranging from 0.5 wt % up to 7 wt %, based on the total weight of the inkjet ink composition, a pigment, a polar solvent, and a balance of water. In this example, no other additives are included in the ink.

Other examples of the inkjet ink composition include the cellulose nanocrystals, the metal oxide, the pigment, the polar solvent, and water, as well as other constituents for the enhancement of print durability and performance, such as a sugar alcohol and an organic salt. In an example, the inkjet ink comprises cellulose nanocrystals present in an amount ranging from 0.5 wt % up to 2 wt %, based on a total weight of the inkjet ink composition, a metal oxide present in an amount ranging from 0.5 wt % up to 7 wt %, based on the total weight of the inkjet ink composition, a pigment, a polar solvent, a sugar alcohol present in an amount ranging from greater than 0 wt % up to about 15 wt %, based on the total weight of the inkjet ink composition, an organic salt present in an amount ranging from about 0.01 wt % to about 0.5 wt %, based on the total weight of the inkjet ink composition, and a balance of water.

In still other examples, the inkjet ink composition, which includes the cellulose nanocrystals, the metal oxide, the pigment, the polar solvent and the balance of water and which may or may not include the sugar alcohol and polar solvent, may also include other additives suitable for inkjet inks, such as, anti-kogation agents, surfactants, dyes, humectants, biocides, materials for pH adjustment, sequestering agents, binders, and the like.

In an example, the inkjet ink composition consists of cellulose nanocrystals present in an amount ranging from 0.5 wt % up to 2 wt %, based on a total weight of the inkjet ink composition, a metal oxide present in an amount ranging from 0.5 wt % up to 7 wt %, based on the total weight of the inkjet ink composition, a pigment, a polar solvent, a sugar alcohol present in an amount ranging from greater than 0 wt % up to about 15 wt %, based on the total weight of the inkjet ink composition, an organic salt present in an amount ranging from about 0.01 wt % to about 0.5 wt %, based on the total weight of the inkjet ink composition, and an additive selected from the group consisting of an anti-kogation agent, a surfactant, a dye, a humectant, a biocide, a material for pH adjustment, a sequestering agent, a binder, and combinations thereof, and a balance of water.

The inkjet ink composition includes the cellulose nanocrystals present in an amount ranging from 0.5 wt % up to 2 wt %, based on a total weight of the inkjet ink composition. Cellulose nanocrystals are organic nanocrystals that are isolated from natural sources, such as wood, bark, plants, etc. In the inkjet ink, the cellulose nanocrystals, along with the metal oxide, functions as a gelator (or network forming agent). Structurally, cellulose nanocrystals are rod-like anisotropic nanocrystals having an aspect ratio as high as 100. In an example, a length of the cellulose nanocrystals ranges from about 100 nm to about 200 nm, and a width ranges from about 2 nm to about 20 nm. In another example, the length of the cellulose nanocrystals ranges from about 150 nm to about 200 nm, and the width ranges from about 5 nm to about 20 nm. The hydrodynamic radius (used to determine width) of the cellulose nanocrystals may be determined using a light scattering tool. Other suitable tools that may be used to measure the length and width of the cellulose nanocrystals include TEM (Transmission Electron Microscopy), AFM (Atomic Force Microscopy), and DLS (Dynamic Light Scattering).

In an example, the cellulose nanocrystals are modified cellulose nanocrystals including surface sulfonate groups, surface carboxylate groups, surface carboxymethyl groups, or a combination thereof. Such surface chemistry allows for electrostatic, hydrogen bond, Van der Waals, and hydrophobic interactions, which make the modified cellulose nanocrystals an excellent network forming agent.

Cellulose nanocrystals may be incorporated into the ink composition as a dry powder or in the form of a suspension. Suitable cellulose nanocrystal suspensions are commercially available. For example, from about 11.5 wt % to about 12.5 wt % aqueous gel cellulose nanocrystals are available from the University of Maine Process Development Center.

As mentioned earlier, the inkjet ink composition also includes the metal oxide. The metal oxide serves as a gelator together with the cellulose nanocrystals. The combination of the rod-like cellulose nanocrystals together with spherical metal oxides may form an effective network building combination. As such, in the example inks disclosed herein, the cellulose nanocrystals in combination with the metal oxide may contribute to more colorant remaining on the media surface, even without the presence of calcium ions, thus resulting in an increase in color saturation on plain paper.

As used herein, the term “metal oxide” refers to a molecule comprising at least one metal or semi-metal (e.g., Si) atom and at least one oxygen atom which in a particulate form is able to form a three dimensional structure in the presence of salt dissolved in an organic solvent and/or water. This three dimensional structure is a structured network. As used herein, the term “semi-metal” includes boron, silicon, germanium, arsenic, antimony, and tellurium, for example. As examples, the metal oxide can include silica (silicon dioxide), alumina (aluminum oxide), titania (titanium dioxide), zinc oxide, iron oxide, indium oxide, zirconium oxide, or mixtures thereof. In an example, the inkjet ink composition includes the metal oxide, wherein the metal oxide is selected from the group consisting of silica, alumina, titanium dioxide, and combinations thereof.

When silica is selected for the metal oxide, it is to be understood that different forms of silica may be used. Suitable forms of silica that may be used include anisotropic silica (e.g., elongated, covalently attached silica particles, such as PSM, which is commercially available from Nissan Chemical) or spherical silica dispersions (such as SNOWTEX® 30LH from Nissan Chemical). Other suitable commercially available silicas are sold under the tradename ORGANOSILICASOL™, which are organic solvent dispersed silica sols. In an example, the inkjet ink composition includes silica, wherein the silica is anisotropic silica, spherical silica or a combination of anisotropic silica and spherical silica. Anisotropic silica dispersions have a higher aspect ratio compared to spherical silica. This may match well with the higher aspect ratio of the cellulose nanocrystals. One type of silica may be more suitable for use with a particular type of inkjet ink formulation relative to another type of inkjet ink formulation. For example, anisotropic silica dispersions may be more suited for cyan inks, whereas spherical silica dispersions may be more suitable for magenta inks.

As discussed herein, the metal oxide (again which is defined to include both metal and semi-metal oxides) can be present in the inkjet ink composition in an amount ranging from 0.5% to 7% by weight based on the total weight of the inkjet ink composition. In one example, the metal oxide can be present in an amount ranging from about 1 wt % to about 5 wt %, based on the total weight of the inkjet ink composition. In another example, the metal oxide can be present in an amount ranging from about 0.5 wt % to about 2 wt %, based on the total weight of the inkjet ink composition.

Additionally, the geometry, including the size, shape and aspect ratio of the metal oxide can influence certain properties of the inkjet ink composition, such as viscosity. For example, at a given weight percent in an ink, metal oxide particles with a higher aspect ratio may yield a higher ink viscosity relative to metal oxide particles with a lower aspect ratio. Also, the viscosity of the ink may be reduced by incorporating a small amount of large sized particles, which act as spacers between smaller nanoparticles in the ink composition, like the smaller nanoparticle components that make up other solids in the ink. In this example, the large sized particles may mediate particle-particle interaction between the smaller nanoparticles to reduce viscosity. In one example, the particle size of the metal oxide may range from about 5 nm to about 50 nm. In another example, the particle size of the metal oxide may range from about 10 nm to about 25 nm.

The inkjet ink composition also includes a pigment. As used herein, “pigment” may include charge dispersed (i.e., self-dispersed) organic or inorganic pigment colorants. The pigment may be any color, including, as examples, a cyan pigment, a magenta pigment, a yellow pigment, a black pigment, a violet pigment, a green pigment, a brown pigment, an orange pigment, a purple pigment, a white pigment, or combinations thereof. The following examples of suitable pigments can be charged and thus made self-dispersible.

Examples of suitable blue or cyan organic pigments include C.I. Pigment Blue 1, C.I. Pigment Blue 2, C.I. Pigment Blue 3, C.I. Pigment Blue 15, Pigment Blue 15:3, C.I. Pigment Blue 15:34, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Examples of suitable magenta, red, or violet organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Red 286, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50.

Examples of suitable yellow organic pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 77, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 122, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 167, C.I. Pigment Yellow 172, C.I. Pigment Yellow 180, and C.I. Pigment Yellow 185.

Carbon black may be a suitable inorganic black pigment. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, the MOGUL® series, or the MONARCH® series manufactured by Cabot Corporation, Boston, Mass., (such as, e.g., REGAL® 400R, REGAL® 330R, REGAL® 660R, MOGUL® E, MOGUL® L, AND ELFTEX® 410); and various black pigments manufactured by Evonik Degussa Orion Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® U, PRINTEX® V, PRINTEX® 140U, Special Black 5, Special Black 4A, and Special Black 4). An example of an organic black pigment includes aniline black, such as C.I. Pigment Black 1.

Some examples of green organic pigments include C.I. Pigment Green 1, C.I. Pigment Green 2, C.I. Pigment Green 4, C.I. Pigment Green 7, C.I. Pigment Green 8, C.I. Pigment Green 10, C.I. Pigment Green 36, and C.I. Pigment Green 45.

Examples of brown organic pigments include C.I. Pigment Brown 1, C.I. Pigment Brown 5, C.I. Pigment Brown 22, C.I. Pigment Brown 23, C.I. Pigment Brown 25, C.I. Pigment Brown 41, and C.I. Pigment Brown 42.

Some examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, and C.I. Pigment Orange 66.

The average particle size of the pigments may range anywhere from about 50 nm to about 200 nm. In an example, the average particle size ranges from about 80 nm to about 150 nm.

The pigment may be incorporated into the inkjet ink composition in the form of a pigment dispersion, in which the pigment is self-dispersed. In the examples disclosed herein, the pigment may be present in the ink composition in an amount ranging from about 2 wt % to about 5 wt % based on the total weight of the ink. In another example, the pigment amount ranges from about 4 wt % to about 5 wt % based on the total weight of the ink. When the pigment is added in the form of a pigment dispersion, the amount of dispersion may be selected so that from about 2% actives (i.e., pigment) to about 5% actives is incorporated into the inkjet ink composition. It is to be understood that the active percentage accounts for the pigment amount, and does not reflect the amount of other dispersion components that may be included.

As mentioned above, the inkjet ink composition includes a polar solvent. It is desirable for the solvent to be miscible with water, and thus the solvent has at least some degree of polarity. In an example, the solvent is selected from the group consisting of 2-pyrrolidone (2P), 1-(2-hydroxyethyl)-2-pyrrolidone (HE2P), 2-ethyl-2-hydroxymethyl-1,3-propanediol) (EHPD), tetraethylene glycol (TEG) and combinations thereof. The solvent may be present in an amount ranging from about 10 wt % to about 90 wt % based on the total weight of the inkjet ink composition. The weight percent of the polar solvent, and thus the weight ratio of polar solvent to water, in the inkjet ink composition may be varied depending on the intended use of the inkjet ink composition (i.e., whether the ink is a thermal inkjet ink or a piezoelectric inkjet ink). For example, when intended for thermal inkjet printing, the amount of polar solvent may be less than or equal to 50 wt % based on the total weight of the inkjet ink composition. On the other hand, when intended for piezoelectric printing, the amount of polar solvent may be greater than or equal to 50 wt %, based on the total weight of the inkjet ink composition.

As will be described further herein, the cellulose nanocrystals, metal oxide and pigment may be incorporated into an ink vehicle to form the inkjet ink composition. As used herein, the term “ink vehicle,” may refer to the liquid fluid in which cellulose nanocrystals, metal oxide and pigment are placed to form the inkjet ink. In an example, the ink vehicle includes the polar solvent and the water. In another example, the ink vehicle includes the polar solvent, water, and other additives such as a sugar alcohol and an organic salt.

As mentioned herein, the inkjet ink composition may include a sugar alcohol. In an example, the inkjet ink composition further includes a sugar alcohol present in an amount ranging from greater than 0 wt % up to about 15 wt % based on the total weight of the inkjet ink composition. In some examples when the inkjet ink composition is a thermal inkjet ink, the sugar alcohol may be present in an amount ranging from 3 wt % up to about 8 wt % based on the total weight of the thermal inkjet ink composition. Sugar alcohol levels higher than 15 wt % can cause a printability issue from a thermal inkjet printhead due to increased viscosity.

The sugar alcohol can be any type of chain or cyclic sugar alcohol. In one example, the sugar alcohol can have the formula: H(HCHO)ₙ₊₁ H, where n is at least 3. Such sugar alcohols can include erythritol (4-carbon), threitol (4-carbon), arabitol (5-carbon), xylitol (5-carbon), ribitol (5-carbon), mannitol (6-carbon), sorbitol (6-carbon), galactitol (6-carbon), fucitol (6-carbon), iditol (6-carbon), inositol (6-carbon; a cyclic sugar alcohol), volemitol (7-carbon), isomalt (12-carbon), maltitol (12-carbon), lactitol (12-carbon), and mixtures thereof. In one example, the sugar alcohol can be a 5 carbon sugar alcohol. In another example, the sugar alcohol can be a 6 carbon sugar alcohol. In still another example, the inkjet ink composition includes a sugar alcohol wherein the sugar alcohol is selected from the group consisting of sorbitol, xylitol, mannitol, erythritol and combinations thereof. The use of a sugar alcohol can provide improved reliability, excellent curl and rub/scratch resistance.

The inkjet ink composition may also include an organic salt. In an example, the inkjet ink composition further includes an organic salt present in an amount ranging from about 0.01 wt % to about 1 wt % based on the total weight of the inkjet ink composition. In another example, the organic salt may be present in an amount ranging from about 0.05 wt % to about 0.5 wt % based on the total weight of the inkjet ink composition.

Examples of the organic salt may include tetraethyl ammonium salts, tetramethyl ammonium salts, acetate salts, etc. In other examples, the organic salt can include salts of carboxylic acids (e.g., sodium or potassium 2-pyrrolidinone-5-carboxylic acid), sodium or potassium acetate, salts of citric acid or any organic acid including aromatic salts, and mixtures thereof. In one example, the organic salt is selected from the group consisting of sodium phthalate, tetraethyl ammonium, tetramethyl ammonium, monosodium glutamate, bis(trimethylsilyl) malonate, magnesium propionate, magnesium citrate, calcium acetate, magnesium acetate, sodium acetate, potassium acetate, barium acetate, and combinations thereof.

The inclusion of a salt, particularly a dissolved salt in the inkjet ink, can further contribute to the structure of the ink. A salt can act to shield the electrostatic repulsion between pigment particles and permit the van der Waals interactions to increase, thereby forming a stronger attractive potential and resulting in a structured network by providing elastic content to a predominantly fluidic system. These structured systems show non-Newtonian flow behavior, thus providing useful characteristics for implementation in an inkjet ink because of their ability to shear thin or thermal thin (in the case of thermal inkjet inks) for jetting. Once jetted, this feature allows the jetted drops to become more elastic-, mass-, or gel-like when they strike the media surface. These characteristics can also provide improved media attributes, such as colorant holdout on the surface of plain paper. Therefore, the role of the organic salt can impact both the jettability of the inkjet ink as well as the response after jetting.

The balance of the inkjet ink composition is water. As such, the amount of water included may vary, depending upon the amounts of the other inkjet ink components. As examples, thermal inkjet compositions may include more water than piezoelectric inkjet compositions. In an example, the water is deionized water.

The total solids content of the inkjet ink composition may be variable depending on the intended use of the ink composition. As mentioned herein, the solids content impacts the viscosity. Where the ink composition is intended for use with thermal inkjet printheads, the viscosity of the ink as measured at ambient conditions (e.g., 25° C., 1 atm) may be less than or equal to 6 cP. However, where the ink composition is intended for use with piezoelectric printheads, the viscosity of the ink as measured at ambient conditions may be greater than or equal to 10 cP.

Most of the solids in the inkjet ink are attributable to the cellulose nanocrystals, metal oxide, and the pigment. In an example, the inkjet ink composition is a thermal inkjet composition, and a total solids content of the (thermal) inkjet ink composition ranges from about 6 wt % to about 8 wt % based on the total weight of the (thermal) inkjet ink composition. In another example, the inkjet ink composition is a piezoelectric inkjet composition, and a total solids content of the (piezoelectric) inkjet ink composition ranges from about 10 wt % to about 25 wt % based on the total weight of the (piezoelectric) inkjet ink composition.

In some examples, the inkjet ink composition may further include a dye. In an example, the inkjet ink composition further includes a dye present in an amount ranging from about 0.1 wt % to about 0.5 wt % based on the total weight of the inkjet ink composition. In another example, the dye is present in an amount ranging from about 0.2 wt % to about 0.5 wt % based on the total weight of the inkjet ink composition. Examples of suitable dyes include azo dyes, phthalocyanine dyes, direct dyes, vat dyes, sulfur dyes, organic dyes, reactive dyes, disperse dyes, acid dyes, or basic dyes. Examples of suitable dyes are commercially available, and include azo dyes (such as PRO-JET™ Fast Magenta 2 Liquid (from Fujifilm, USA)), and phthalocyanine dye (Nippon Kayaku, Japan). The dye may also be any desirable color, such as black, magenta, cyan, yellow, etc.

As mentioned previously herein, examples of the inkjet ink composition may also include other components, such as anti-kogation agents, surfactants, humectants, biocides, materials for pH adjustment, sequestering agents, binders, and the like.

Kogation refers to the deposit of dried ink on a heating element of a thermal inkjet printhead. Anti-kogation agent(s) is/are included in thermal inkjet ink formulations to assist in preventing the buildup of kogation. Examples of suitable anti-kogation agents include oleth-3-phosphate (commercially available as CRODAFOS™ 03 A or CRODAFOS™ N-3 acid) or dextran 500k. Other suitable examples of the anti-kogation agents include CRODAFOS™ HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc. The anti-kogation agent may be present in the inkjet ink composition in an amount ranging from about 0.01 wt % to about 1 wt % of the total weight of the inkjet ink composition. In another example, the anti-kogation agent may be present in the inkjet ink composition in an amount ranging from about 0.01 wt % to about 0.1 wt % of the total weight of the inkjet ink composition. In the examples disclosed herein, the anti-kogation agent may improve the jettability of the inkjet ink, for example, when jetted from a thermal inkjet printhead.

Examples of suitable surfactants include sodium dodecyl sulfate (SDS), a linear, N-alkyl-2-pyrrolidone (e.g., SURFADONE™ LP-100 from Ashland Inc.), a self-emulsifiable, nonionic wetting agent based on acetylenic diol chemistry (e.g., SURFYNOL® SEF from Evonik Ind.), a nonionic fluorosurfactant (e.g., CAPSTONE® fluorosurfactants, such as CAPSTONE® FS-35, from DuPont, previously known as ZONYL FSO), and combinations thereof. In other examples, the surfactant is an ethoxylated low-foam wetting agent (e.g., SURFYNOL® 440 or SURFYNOL® CT-111 from Evonik Ind.) or an ethoxylated wetting agent and molecular defoamer (e.g., SURFYNOL® 420 from Evonik Ind.). Still other suitable surfactants include non-ionic wetting agents and molecular defoamers (e.g., SURFYNOL® 104E from Evonik Ind.) or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TEGO® Wet 510 (polyether siloxane) available from Evonik Ind.). In some examples, it may be desirable to utilize a surfactant having a hydrophilic-lipophilic balance (HLB) less than 10. Whether a single surfactant is used or a combination of surfactants is used, the total amount of surfactant(s) in the inkjet ink composition may range from about 0.01 wt % to about 10 wt % based on the total weight of the inkjet ink composition. In another example, the total amount of surfactant(s) in the inkjet ink composition may be about 0.01 wt % to about 0.1 wt % based on the total weight of the inkjet ink composition. In still another example, the total amount of surfactant(s) in the inkjet ink composition may be about 0.05 wt % based on the total weight of the inkjet ink composition.

The inkjet ink composition may also include humectant(s). In an example, the total amount of the humectant(s) present in the inkjet ink composition ranges from about 1 wt % to about 1.5 wt %, based on the total weight of the inkjet ink composition. In another example, the total amount of the humectant(s) present in the inkjet ink composition ranges from about 1 wt % to about 1.25 wt %, based on the total weight of the inkjet ink composition. An example of a suitable humectant is LIPONIC® EG-1 (i.e., LEG-1, glycereth-26, ethoxylated glycerol, available from Lipo Chemicals).

The inkjet ink composition may also include biocides (i.e., fungicides, anti-microbials, etc.). Example biocides may include the NUOSEPT™ (Troy Corp.), UCARCIDE™ (Dow Chemical Co.), ACTICIDE® B20 (Thor Chemicals), ACTICIDE® M20 (Thor Chemicals), ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof. Examples of suitable biocides include an aqueous solution of 1,2-benzisothiazolin-3-one (e.g., PROXEL® GXL from Arch Chemicals, Inc.), quaternary ammonium compounds (e.g., BARDAC® 2250 and 2280, BARQUAT® 50-65B, and CARBOQUAT® 250-T, all from Lonza Ltd. Corp.), and an aqueous solution of methylisothiazolone (e.g., KORDEK® MLX from Dow Chemical Co.). In an example, the inkjet ink composition may include a total amount of biocides that ranges from about 0.05 wt % to about 1 wt %.

The inkjet ink composition disclosed herein may have a pH ranging from about 7 to about 10, and pH adjuster(s) may be added to the inkjet ink composition to counteract any slight pH drop that may occur over time. In an example, the total amount of pH adjuster(s) in the inkjet ink composition ranges from greater than 0 wt % to about 0.1 wt % (with respect to the total weight of the inkjet ink composition). Examples of suitable pH adjusters include metal hydroxide bases, such as sodium hydroxide (NaOH), potassium hydroxide (KOH), etc.

Sequestering agents (or chelating agents) may be included in the inkjet ink composition to eliminate the deleterious effects of heavy metal impurities. Examples of sequestering agents include disodium ethylenediaminetetraacetic acid (EDTA-Na), ethylene diamine tetra acetic acid (EDTA), and methylglycinediacetic acid (e.g., TRILON® M from BASF Corp.). Whether a single sequestering agent is used or a combination of sequestering agents is used, the total amount of sequestering agent(s) in the inkjet ink composition may range from greater than 0 wt % to about 2 wt % based on the total weight of the inkjet ink composition.

The inkjet ink composition may also include a binder. Example binders may include a polyurethane binder, a styrene acrylic binder, or the like. In an example, the inkjet ink composition may include a total amount of binder up to about 1 wt % based on the total weight of the inkjet ink composition. In another example, the binder amount ranges from greater than 0 wt % to about 0.6 wt % based on the total weight of the inkjet ink composition.

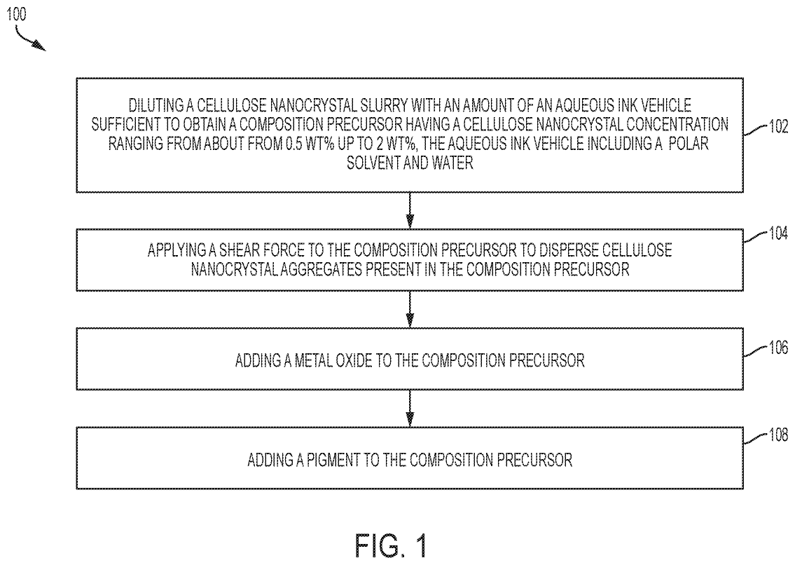

In addition to the inkjet ink composition described herein, a method 100 for making the inkjet ink composition is disclosed. Turning now to FIG. 1, the method 100 comprises diluting a cellulose nanocrystal slurry with an amount of an aqueous ink vehicle sufficient to obtain a composition precursor having a cellulose nanocrystal concentration ranging from about from 0.5 wt % up to 2 wt %, the aqueous ink vehicle including a polar solvent and water (as shown at reference numeral 102); applying a shear force to the composition precursor to disperse cellulose nanocrystal aggregates present in the composition precursor (as shown at reference numeral 104); adding a metal oxide to the composition precursor (as shown at reference numeral 106); and adding a pigment to the composition precursor (as shown at reference numeral 108).

In one example, the cellulose nanocrystal slurry may be a commercially available suspension that has at least 10% w/v of cellulose nanocrystals. At this concentration, the aggregates are likely to be present in the slurry, and the subsequent application of shear force can help to disperse the aggregates into individual cellulose nanocrystals.

In another example, prior to diluting the cellulose nanocrystal slurry, the method may further comprise making the cellulose nanocrystal slurry so that a concentration of cellulose nanocrystals in the cellulose nanocrystal slurry is at least 10% w/v, and the cellulose nanocrystal aggregates form in the cellulose nanocrystal slurry.

The cellulose nanocrystal slurry may be formed by exposing a dispersion of cellulose microfibrils to acid hydrolysis, followed by sonication, purification, and water reduction.

When preparing the slurry, acid hydrolysis may be accomplished using sulfuric acid, hydrochloric acid, or combinations thereof. The sulfuric acid or the combination of hydrochloric and sulfuric acids may be used when it is desirable to introduce at least some sulfonate groups to the surface of the cellulose nanocrystals to form self-dispersed cellulose nanocrystals. As such, in some examples the cellulose nanocrystal slurry includes cellulose nanocrystals including surface sulfonate groups, and the method 100 further comprises forming the cellulose nanocrystal slurry by exposing a dispersion of cellulose nanocrystals to acid hydrolysis using sulfuric acid. In other examples, the hydrochloric acid may be used when sulfonation is not desired. This process forms another example of the cellulose nanocrystals. In some examples, after acid hydrolysis, the method may further comprise exposing the cellulose nanocrystals to oxidants or esterification agents to obtain at least partially carboxylated cellulose nanocrystals. In other examples, additional sulfuric acid may be added in order to enrich the degree of sulfonation.

After acid hydrolysis, a 1% or lower concentration of cellulose nanocrystal slurry may be obtained, which may be exposed to further purification and water reduction. The purification and water reduction may be accomplished by centrifugation, which may be performed once or multiple times, e.g., at least 3.

Purified cellulose nanocrystal slurries can be spray dried, freeze dried, or prepared into a slurry of at least 10% w/v cellulose nanocrystal concentration by adjusting the water amount. These techniques may result in the formation of cellulose nanocrystal aggregates. Spray dried or freeze dried cellulose nanocrystal aggregates may also be added to water to form a slurry of the desired concentration.

It may then be desirable to expose the slurry to sonication to re-disperse the cellulose nanocrystals. While sonication may be used with any of the cellulose nanocrystals that are formed, it may be particularly desirable for the cellulose nanocrystals formed with hydrochloric acid, as these cellulose nanocrystals do not have surface charged groups to achieve self-dispersion, and the sonication can aid in the dispersion of these types of cellulose nanocrystals.

At reference numeral 104, the method 100 continues by applying a shear force to the composition precursor to disperse cellulose nanocrystal aggregates present in the composition precursor. The parameters involved with the application of shear force depend, at least in part, on the technique used to apply the force, the volume of the composition precursor, and the cellulose nanocrystal loading in the composition precursor. In an example of the method 100, the shear force is applied using sonication. Sonication may be performed at a frequency ranging from about 20 kHz to about 40 kHz. The sonication may be performed on ice for a time ranging from about 2 minutes to about 6 minutes. In an example, about 150 mL of the composition precursor may be sonicated, although the volume may be adjusted depending on the probe tip diameter used. As examples, a 55 mm diameter probe may be used with volumes of about 150 mL or less, whereas a 6 mm probe may be used with volumes of about 15 mL of less.

At reference numeral 106, the method 100 further includes adding a metal oxide to the composition precursor. The metal oxide is added after the application of the shear force.

At reference numeral 108, the method 100 further includes adding a pigment to the composition precursor. The pigment can be added in the form of a powder or it can be added in the form of a dispersion (i.e., pigment dispersed in another liquid, for example water). In some examples, the pigment may be added before or after shearing of the composition precursor takes place. In other examples, the pigment may be added before or after the metal oxide has been added to the composition precursor. In still other examples, both the pigment and the metal oxide may be added to the composition precursor at the same time after shearing takes place.

In an example of the method 100 that is suitable for making a thermal inkjet ink composition, adding the pigment and the metal oxide (to the composition precursor) forms the inkjet ink composition, the metal oxide is added in an amount ranging from 0.5 wt % up to 7 wt % based on a total weight of the inkjet ink composition, and a total solids content of the inkjet ink composition ranges from about 6 wt % to about 8 wt % based on the total weight of the thermal inkjet ink composition. To make an example of a piezoelectric inkjet formulation the polar solvent amount and the solids content may be increased in accordance with the amounts set forth herein.

A printing method using the inkjet ink composition is also disclosed herein. The method comprises introducing a paper into an inkjet printer, and from the inkjet printer, jetting the ink composition onto the paper to form an image, the ink composition including cellulose nanocrystals present in an amount ranging from 0.5 wt % up to 2 wt %, based on a total weight of the inkjet ink composition, a metal oxide present in an amount ranging from 0.5 wt % up to 7 wt %, based on the total weight of the inkjet ink composition, the pigment, a polar solvent, and a balance of water.

In an example, the paper used in the printing method is select selected from the group consisting of a plain paper and an enhanced paper, the plain paper excluding an additive that produces a chemical interaction with the pigment in the ink composition that is printed thereon, and the enhanced paper including an additive that produces a chemical interaction with the pigment in the ink composition.

In some examples, the printing method further comprises jetting the ink composition onto both a plain paper to form an image and onto an enhanced paper to form an other image, wherein color saturation of the image on the plain paper is within 0.25 of color saturation of the other image on the enhanced paper at any given % fill density. In these examples, the paper types may be printed on in any order and may take place in back-to-back print cycles or in print cycles that take place at different times.

To further illustrate the present disclosure, examples are given herein. It is to be understood that these examples are provided for illustrative purposes and are not to be construed as limiting the scope of the present disclosure.

### EXAMPLES

Examples of cyan inks (examples 1-3) were prepared in accordance with the examples disclosed herein. One comparative cyan ink (comparative example 4) was prepared that did include a metal oxide, but did not include the cellulose nanocrystals. Another comparative cyan ink (comparative example 5) was prepared that did not include either the cellulose nanocrystals or the metal oxide. The formulations of the cyan examples and cyan comparative examples are presented in Table 1 below. The percentages represent weight percentages of actives of the individual components.

TABLE 1

| | | | | | Cyan | Cyan |
|---|---|---|---|---|---|---|
| | | Cyan | Cyan | Cyan | Comp. | Comp. |
| | Specific | Example 1 | Example 2 | Example 3 | Example 4 | Example 5 |
| Ingredient | Component | (wt %) | (wt %) | (wt %) | (wt %) | (wt %) |
| Network | Cellulose nanocrystals | 0.5 | 0.7 | 1.5 | 0 | 0 |
| Agent | Silica (PSM) | 3.5 | 1.75 | 2.5 | 2 | 0 |
| Polar | 2-pyrrolidone | 15 | 10 | 10 | 10 | 0 |
| Solvent | Triethylene glycol | 0 | 7 | 5 | 0 | 0 |
| | 1-(2-Hydroxyethyl)- | 0 | 0 | 0 | 6 | 0 |
| | 2-pyrrolidone) | | | | | |
| | Mixture of glycols | 0 | 0 | 0 | 0 | 21.5 |
| | and 2-pyrrolidone | | | | | |
| Sugar | Sorbitol | 7 | 5 | 5 | 6 | 0 |
| alcohol | Erythritol | 0 | 3 | 0 | 0 | 0 |
| Colorants | CAB-O-JET ® 450C | 4.5 | 4.5 | 4 | 5 | 0 |
| | cyan pigment | | | | | |
| | (Cabot Corp.) | | | | | |
| | Phthalocyanine dye | 0.25 | 0.35 | 0.25 | 0.25 | 0 |
| | (Nippon Kayaku) | | | | | |
| | Polymer dispersed | 0 | 0 | 0 | 0 | 3 |
| | cyan pigment | | | | | |
| Humectant | LIPONIC ® EG-1 | 1.25 | 1 | 1.25 | 1 | 0 |
| | (Lipo Chemicals) | | | | | |
| Binder | Polyurethane binder | 0 | 0.4 | 0 | 0 | 0 |
| | Proprietary polymer | 0 | 0 | 0 | 0 | 1 |
| Organic | Sodium phthalate | 0.1 | 0.15 | 0 | 0 | 0 |
| salt | | | | | | |
| Surfactant | Sodium dodecyl | 0.05 | 0.05 | 0.05 | 0.05 | 0 |
| | sulfate | | | | | |
| | Non-ionic | 0 | 0 | 0 | 0 | 0.6 |
| | surfactants | | | | | |
| Anti- | CRODAFOS ™ O3A | 0.05 | 0.05 | 0.05 | 0.05 | 0 |
| kogation | (Croda Int.) | | | | | |
| Agent | | | | | | |
| Water | Deionized Water | Balance | Balance | Balance | Balance | Balance |
| pH 9 | | | | | | |

The water, polar solvent(s), sugar alcohols, humectant, surfactant, and anti-kogation agent, and where applicable, binder and organic salt, were mixed together to form cyan aqueous ink vehicles. The example inks were prepared using a cellulose nanocrystal slurry (11.8% w/v) available from the University of Maine Process Development Center. Applicable amounts of the slurry were added to the respective aqueous ink vehicles to obtain the weight percent of cellulose nanocrystals listed in Table 1, and to form cyan ink composition precursors. The composition precursors were exposed to sonication to apply shear force and to break cellulose nanocrystal agglomerates and liberate individual cellulose nanocrystals. Sonication was performed at a frequency ranging from about 20 kHz to about 40 kHz using a 55 mm probe tip diameter. 150 mL of each of the cyan composition precursor was sonicated at a time, and the sonication was performed on ice for a time ranging from about 2 minutes to about 6 minutes, or until a clear suspension was obtained.

The silica, cyan pigment, and cyan dye were added to the clear suspension (with the vehicle components), to yield the example cyan inkjet inks.

For comparative example 4, the water, polar solvents, sugar alcohol, humectant, surfactant, and anti-kogation agent were mixed together to form a cyan aqueous ink vehicle. The silica, cyan pigment, and cyan dye were added to the clear suspension (with the vehicle components), to yield the comparative example cyan inkjet ink (comparative example 4).

For comparative example 5, the water, polar solvents, binder, and surfactants were mixed together to form a cyan aqueous ink vehicle. The cyan pigment dispersion was added to the clear suspension (with the vehicle components), to yield the comparative example cyan inkjet ink (comparative example 5).

Examples of magenta inks (examples 6 and 7) were also prepared in accordance with the examples disclosed herein. One comparative magenta ink (comparative example 8) was prepared that included a metal oxide, but did not include the cellulose nanocrystals. Another comparative magenta ink (comparative example 9) was prepared that did not include either the cellulose nanocrystals or the metal oxide. The formulations of the magenta examples and the magenta comparative examples are presented in Table 2 below. The percentages represent weight percentages of actives of the individual components.

TABLE 2

| | | | | Magenta | Magenta |
|---|---|---|---|---|---|
| | | Magenta | Magenta | Comp. | Comp. |
| | | Example 6 | Example 7 | Example 8 | Example 9 |
| Ingredient | Specific Component | (wt %) | (wt %) | (wt %) | (wt %) |
| Network | Cellulose nanocrystals | 1 | 1 | 0 | 0 |
| Agent | SNOWTEX ® 30LH | 3 | 2 | 4 | 0 |
| | Silica | | | | |
| | (Nissan Chemical) | | | | |
| | ORGANOSILICASOL ™ ZL | 0 | 1 | 0 | 0 |
| | Silica sol | | | | |
| | (Nissan Chemical) | | | | |
| Polar | 2-pyrrolidone | 13 | 15 | 10 | 0 |
| Solvent | Triethylene glycol | 5 | 0 | 0 | 0 |
| | 1-(2-Hydroxyethyl)-2- | 0 | 0 | 5 | 0 |
| | pyrrolidone) | | | | |
| | Mixture of glycols and 2- | 0 | 0 | 0 | 21.5 |
| | pyrrolidone | | | | |
| Sugar | Sorbitol | 7 | 7 | 10 | 0 |
| alcohol | | | | | |
| Colorants | CAB-O-JET ® 465M | 4.5 | 4.5 | 4.5 | 0 |
| | magenta pigment | | | | |
| | (Cabot Corp.) | | | | |
| | PRO-JET ™ Fast Magenta | 0.35 | 0.25 | 0.4 | 0 |
| | 2 dye | | | | |
| | (Fujifilm USA) | | | | |
| | Polymer dispersed | 0 | 0 | 0 | 4.3 |
| | magenta pigment | | | | |
| Binder | Polyurethane binder | 0 | 0 | 0.25 | 0 |
| | Proprietary polymer | 0 | 0 | 0 | 1 |
| Organic | Sodium phthalate | 0.15 | 0.1 | 0.2 | 0 |
| salt | | | | | |
| Surfactant | SURFADONE ™ LP-100 | 0.05 | 0.05 | 0.1 | 0 |
| | (Ashland Inc.) | | | | |
| | Non-ionic surfactants | 0 | 0 | 0 | 0.6 |
| Water | Deionized Water | Balance | Balance | Balance | Balance |
| pH 9 | | | | | |

The water, polar solvent(s), sugar alcohol, organic salt, and surfactant were mixed together to form magenta aqueous ink vehicles. The example magenta inks 6 and 7 were prepared using a cellulose nanocrystal slurry (11.8% w/v) available from the University of Maine Process Development Center. Applicable amounts of the slurry were added to the respective aqueous ink vehicles to obtain the weight percent of cellulose nanocrystals listed in Table 2, and to form magenta ink composition precursors. The magenta ink composition precursors were exposed to sonication as described above for the cyan example inks.

The silica and magenta pigment and dye were added to the clear suspension (with the magenta vehicle components), to obtain the example magenta inkjet inks 6 and 7.

For comparative example 8, the water, polar solvents, sugar alcohol, organic salt, surfactant, and binder were mixed together to form a magenta aqueous ink vehicle. The silica and magenta pigment and dye were added to the clear suspension (with the vehicle components), to yield the comparative example magenta inkjet ink (comparative example 8).

For comparative example 9, the water, polar solvents, binder, and surfactants were mixed together to form a magenta aqueous ink vehicle. The magenta pigment dispersion was added to the clear suspension (with the vehicle components), to yield the comparative example magenta inkjet ink (comparative example 9).

Each of the cyan and magenta inks and comparative inks, was printed with a thermal inkjet printer, the HP® OFFICEJET® Pro 8000 on a plain paper (Georgia-Pacific Spectrum Multipurpose paper, referred to herein as PP), and on an enhanced paper (HP® Multipurpose paper media with COLORLOK® technology, referred to herein as EP). These inks were printed at different percentages of fill density (ranging from 42% to 54%).

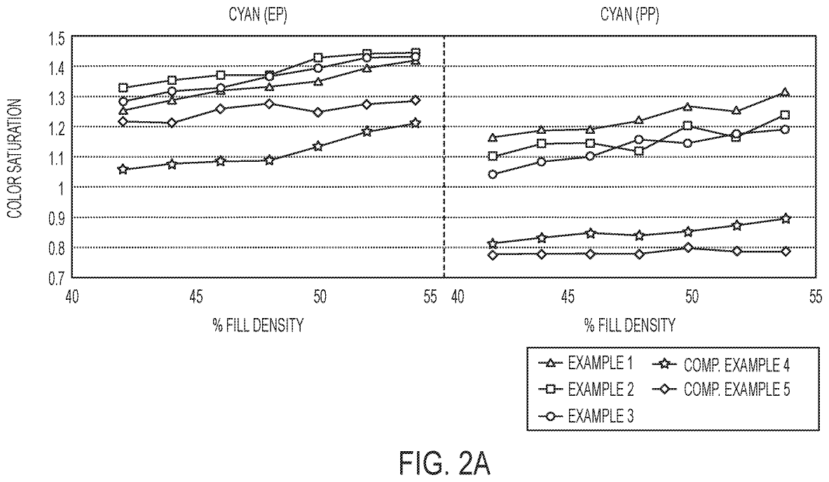

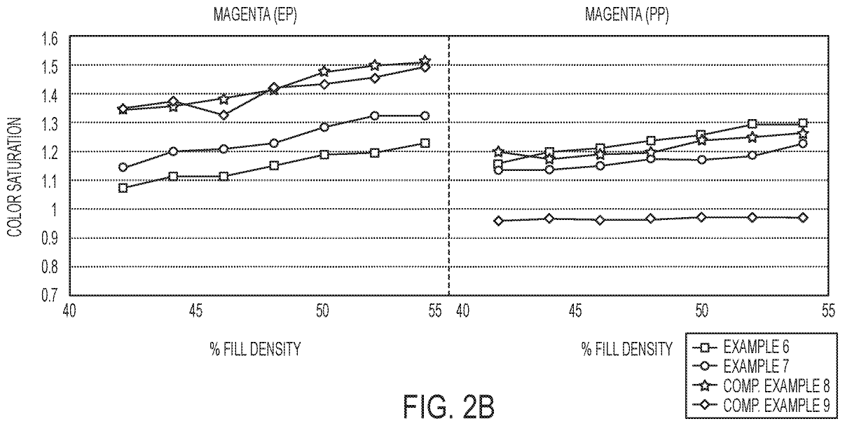

The color saturation of each printed image was measured using an EXACT™ spectrophotometer, from X-Rite Pantone. The color saturation results for the cyan inks and the comparative cyan inks at the different fill densities on the different papers are shown in FIG. 2A, and the color saturation results for the magenta inks and the comparative magenta inks at the different fill densities on the different papers are shown in FIG. 2B.

As shown in FIGS. 2A and 2B, each of the cyan example inks 1-3 and the magenta example inks 6 and 7 exhibited similar color saturation results on each of the plain and enhanced papers. Both the cyan example inks 1-3 and the magenta example inks 6 and 7 exhibited an upward trend in color saturation as the fill density increased on the enhanced paper. For each of the example inks 1-3, 6, and 7, this trend was also observed on the plain paper. These results illustrate that both the cyan and magenta example inks are media independent in terms of color performance.

As shown in FIG. 2A, the color saturation performance of comparative example 4 was worse on both plain paper and on enhanced paper when compared to each of examples 1-3. These results indicate that the combination of the cellulose nanocrystals and metal oxide improves the color performance of cyan inks when compared to a cyan ink that includes the metal oxide but not the cellulose nanocrystals.

Also shown in FIG. 2A, the color saturation performance of comparative example 5 was worse on both plain paper and on enhanced paper when compared to each of examples 1-3. These results indicate that the combination of the cellulose nanocrystals and metal oxide improves the color performance of cyan inks when compared to a cyan ink that includes neither the metal oxide nor the cellulose nanocrystals.

As shown in FIG. 2B, the color saturation performance of comparative example 8 (with metal oxide but not cellulose nanocrystals) was worse on the plain paper than on the enhanced paper. In contrast, example magenta ink 6 (including both metal oxide and cellulose nanocrystals) had improved color saturation performance on the plain paper, and example magenta ink 7 (including both metal oxide and cellulose nanocrystals) had relatively consistent color saturation performance across the plain and enhanced papers. These results indicate that the combination of the cellulose nanocrystals and metal oxide improves or at least maintains the color performance of magenta inks across different media types.

Also as shown in FIG. 2B, the color saturation performance of comparative example 9 (without metal oxide and without cellulose nanocrystals) was worse on the plain paper than on the enhanced paper. In contrast, both example magenta inks 6 and 7 (both including both metal oxide and cellulose nanocrystals) had improved color saturation performance on the plain paper when compared to comparative example 9. These results indicate that the combination of the cellulose nanocrystals and metal oxide improves the color performance of magenta inks on plain paper.

It is to be understood that the ranges provided herein include the stated range and any value or sub-range within the stated range, as if the value(s) or sub-range(s) within the stated range were explicitly recited. For example, a range from 0.5 wt % up to 2 wt % should be interpreted to include not only the explicitly recited limits of 0.5 wt % up to 2 wt %, but also to include individual values, such as 0.75 wt %, 1.25 wt %, 1 wt %, 1.55 wt %, etc., and sub-ranges, such as from about 0.65 wt % to about 1.9 wt %, from about 0.5 wt % to about 1.7 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. An inkjet ink composition, comprising:
cellulose nanocrystals present in an amount ranging from 0.5 wt % up to 2 wt %, based on a total weight of the inkjet ink composition;
a metal oxide present in an amount ranging from 0.5 wt % up to 7 wt %, based on the total weight of the inkjet ink composition;
a pigment;
a polar solvent; and
a balance of water.

2. The inkjet ink composition as defined in claim 1 wherein a total solids content of the inkjet ink composition ranges from about 6 wt % to about 8 wt % based on the total weight of the inkjet ink composition.

3. The inkjet ink composition as defined in claim 1 wherein a length of the cellulose nanocrystals ranges from about 100 nm to about 200 nm, and a width ranges from about 2 nm to about 20 nm.

4. The inkjet ink composition as defined in claim 1 wherein the cellulose nanocrystals are modified cellulose nanocrystals including surface sulfonate groups, surface carboxylate groups, surface carboxymethyl groups, or a combination thereof.

5. The inkjet ink composition as defined in claim 1, further comprising a sugar alcohol present in an amount ranging from greater than 0 wt % up to about 15 wt % based on the total weight of the inkjet ink composition.

6. The inkjet ink composition as defined in claim 5 wherein the sugar alcohol is selected from the group consisting of sorbitol, xylitol, mannitol, erythritol and combinations thereof.

7. The inkjet ink composition as defined in claim 1, further comprising an organic salt present in an amount ranging from about 0.01 wt % to about 0.5 wt % based on the total weight of the inkjet ink composition.

8. The inkjet ink composition as defined in claim 1, further comprising a dye present in an amount ranging from about 0.1 wt % to about 0.5 wt % based on the total weight of the inkjet ink composition.

9. The inkjet ink composition as defined in claim 1 wherein the metal oxide is selected from the group consisting of silica, alumina, titanium dioxide and combinations thereof.

10. The inkjet ink composition as defined in claim 9 wherein the silica is anisotropic silica, spherical silica or a combination of anisotropic silica and spherical silica.

11. A method for making an inkjet ink composition, comprising:
diluting a cellulose nanocrystal slurry with an amount of an aqueous ink vehicle sufficient to obtain a composition precursor having a cellulose nanocrystal concentration ranging from about from 0.5 wt % up to 2 wt %, the aqueous ink vehicle including:
a polar solvent; and
water;
applying a shear force to the composition precursor to disperse cellulose nanocrystal aggregates present in the composition precursor;
adding a metal oxide to the composition precursor; and
adding a pigment to the composition precursor.

12. The method as defined in claim 11 wherein:
adding the metal oxide and the pigment forms the inkjet ink composition;
the metal oxide is added in an amount ranging from 0.5 wt % up to 7 wt % based on a total weight of the inkjet ink composition; and
a total solids content of the inkjet ink composition ranges from about 6 wt % to about 8 wt % based on the total weight of the inkjet ink composition.

13. The method as defined in claim 11 wherein the shear force is applied using sonication.

14. A printing method, comprising:
introducing a paper into an inkjet printer; and
from the inkjet printer, jetting the ink composition onto the paper to form an image, the ink composition including:
cellulose nanocrystals present in an amount ranging from 0.5 wt % up to 2 wt %, based on a total weight of the inkjet ink composition;
a metal oxide present in an amount ranging from 0.5 wt % up to 7 wt %, based on the total weight of the inkjet ink composition;
the pigment;
a polar solvent; and
a balance of water.

15. The printing method as defined in claim 14 wherein the paper is select selected from the group consisting of a plain paper and an enhanced paper, the plain paper excluding an additive that produces a chemical interaction with the pigment in the ink composition that is printed thereon, and the enhanced paper including an additive that produces a chemical interaction with the pigment in the ink composition.
